(19) United States
(12) Patent Application Publication
(10) Pub. No.: US 2021/0363960 A1
(43) Pub. Date: Nov. 25, 2021

(54) MACHINE FOR DRIVING AN ELECTRIC GENERATOR

(71) Applicant: Ernest William Townsend, IV, Scottsdale, AZ (US)

(72) Inventor: Ernest William Townsend, IV, Scottsdale, AZ (US)

(21) Appl. No.: 17/396,723

(22) Filed: Aug. 8, 2021

Related U.S. Application Data
(63) Continuation of application No. 16/788,683, filed on Feb. 12, 2020.

(51) Int. Cl. F03B 17/04; F03B 17/02; F03G 3/00

(52) U.S. Cl. CPC F03B 17/04; F03G 3/00; F03B 17/025

(57) ABSTRACT

A machine for driving an electric generator moves a power module through a DOWN and UP duty cycle along a closed-loop, vertically oriented pathway. In the DOWN portion of the duty cycle, the module falls through air under the influence of gravity and generates kinetic energy for work to drive the electric generator. Upon disengagement of the power module from the electric generator, the kinetic energy of the power module then dives the power module into a bi-level water tank for a subsequent UP portion of the duty cycle. A valve mechanism and a displacement device are submerged in the bi-level tank to cooperate, in combination with each other, to create an unobstructed underwater pathway for the power module through the bi-level tank. The power module then rises under the influence of buoyancy to generate sufficient momentum for exit from the bi-level tank, and a consecutive duty cycle.

### FIELD OF THE INVENTION

The present invention pertains generally to a machine that drives an electric generator for the purpose of generating electricity. This machine is driven by motive forces which are created by the earth's gravitational field. Specifically, the motive forces involved are gravity and buoyancy.

### BACKGROUND OF THE INVENTION

In overview, the machine of the present invention uses the weight of a power module as it falls through air from an elevated start point to drive an electric generator. Upon disengagement from the generator, the power module falls into a bi-level water tank where its buoyancy overcomes its weight. The power module then returns through the bi-level tank by buoyancy to the start point to begin another duty cycle. Thus, the machine operationally employs a tradeoff between the power module's weight and its buoyancy. As envisioned for the present invention, several power modules can be employed to provide for a continuous generation of electricity.

From an engineering perspective, the movement of a power module through a duty cycle will involve several different physical phenomena. Individually, these phenomena are all well known, and in many instances they are elementary. An understanding as to how these physically different phenomena are interactively combined is essential. Importantly, Newton's Second Law (F=ma) is used effectively and the first law of thermodynamics concerning conservation of energy is not violated. With this in mind, an appreciation of the dynamics of a moving object is necessary.

A dynamics analysis involves an evaluation of the motive forces that act to change the velocity of an object. As is well known, accelerations and decelerations respectively increase or decrease the velocity of an object. In the specific situation where the velocity remains constant, it is common to refer to the situation as being “steady state” In any event, it is important to consider that whenever an object is moving, a drag force (D) is generated that acts against the movement of the object.

In the context of the present invention, the only motive forces acting on an object are the object's weight (W) and its buoyancy (B). It is due to these forces, and these forces alone, that the object moves and has velocity. However, when the object is required to alternately move through air and water, the forces of buoyancy (B) and drag (D) will change due to physical differences between the medium through which the object is moving. Consequently, a consideration of an object's velocity is important for several reasons. Most importantly are the work/energy relationship and the impulse/momentum relationship.

Briefly, it is well known that the work/energy relationship is derived from Newton's Second Law: F=ma. In this relationship, F is a force, m is the mass of an object and a is the object's acceleration. Further, work (U) is mathematically defined by a force/distance relationship in the equation U=∫Fds. Energy, on the other hand, is defined as the capacity of a moving object to do work (U). Using the definition and F=ma in the equation U=∫Fds, it can be mathematically derived that work results from a kinetic energy that is equal to ½ mv² wherein v is the object's velocity.

The impulse/momentum relationship, like the work/energy relationship, is also derived from Newton's Second Law. In this case, however, the impulse (l) of a force is mathematically defined as a force/time relationship by the equation l=∫Fdt. Again, using F=ma, the equation l=∫Fdt can be mathematically derived to show that the impulse of a moving object is due to a change in its momentum mv. Stated differently, the equation l=∫Fdt tells us that impulse provides the impetus for an object to keep moving. Physically, this impetus is equal to a change in the object's momentum over an interval of time dt.

With the above in mind, it is an object of the present invention to use the earth's gravitational field as a source of renewable energy for the purpose of generating electric power. Another object of the present invention is to employ the work/energy and impulse/momentum relationships for the purpose of operating a machine that will drive an electric generator. It is also an object of the present invention to provide a mechanical engineer with the disclosure of an innovative technology that teaches how to make and use the technology of the present invention for the benefit of mankind.

For purposes of disclosure, the following definitions and notations are provided for easy reference when considering the descriptions of structure and operation of the present invention as set forth in the specification for the present invention.

### Definitions

Buoyancy means the apparent loss in weight of a body when wholly or partly immersed in a fluid; due to the upthrust exerted by the fluid.

Coefficient of drag (C_{D}) is a numerical multiplier that quantifies drag.

Control means an instrument or apparatus to regulate a machine.

Dive means to plunge into water.

Drag (D) is the force resistance to the motion of an object through a fluid.

Dynamics is the branch of mechanics dealing with the motions of material bodies under the action of given forces.

Energy is the capacity to do work.

Force is the action of one body on another.

Gravity is the force that attracts a body toward the center of the earth.

Head Height is a distance representing the height above a datum which would give a unit mass of a fluid in a conduit a potential energy equal to the sum of its actual potential energy, its kinetic energy and its pressure energy.

Impulse means to drive or impel with a sudden force.

Kinetic energy is the capacity for doing work by virtue of the motion of the body. Mathematically equal to ½ mv² where m is mass and v is the velocity of the body.

Momentum is the impetus (force) that keeps an object moving. Mathematically equal to mv.

Potential energy is the capacity for doing work by virtue of the position of the body.

Power is the time-rate of doing work.

Sink means to go below the surface of water.

Steady-State is an operation that does not change with time and therefore maintains a state of relative equilibrium.

Submerge means to be covered with water.

Terminal velocity means the constant speed that a freely falling (moving) body eventually reaches when the resistance of the medium through which it is falling (moving) prevents further acceleration.

Thermodynamics is the branch of physics dealing with the laws governing conversions of energy.

Work is the product of the magnitude of a force and the distance moved by its point of application along the line of action of the force (i.e. force×distance).

### Notations

A is the area of a flat surface.

B is the force of buoyancy.

C_{D} is coefficient of drag.

D is a drag force.

d is a displacement distance.

F is a force.

h is a head height.

l is an impulse force.

m is mass.

p is pressure.

s is a distance.

Tₑ is a power module engagement time interval.

t is time.

U is work.

V is volume.

Vₘ is power module volume.

V_{d} is displacement volume.

v is velocity.

vₑ is module engagement velocity (steady state).

vₜ is module terminal velocity (steady state).

W is weight.

### SUMMARY OF THE INVENTION (OPERATION)

In general overview, an operation of the present invention is based on a DOWN and UP, closed-loop pathway that is followed by a power module during consecutive duty cycles. During the DOWN portion of a duty cycle, the predominant motive force acting on the power module is its weight W. During the UP portion of the duty cycle, however, the predominant motive force acting on the power module is its buoyancy B. A transfer of the motive force from W to B, and back to W, is the direct result of the fluid medium (e.g. air or water) in which the power module is moving. As a general statement, the power module's weight W dominates as the power module initially falls through air and then dives (plunges) into water during the DOWN portion of the duty cycle. Its buoyancy B thereafter dominates as the power module first decelerates and then rises in water for the UP portion of the duty cycle. This transfer of motive force dominance is possible due to the structure and operation of a bi-level tank.

There are two points in a power module's duty cycle where the motive force acting on the power module changes between W and B. The first is a change from W to B when the power module first enters the bi-level tank. The second is a change from B to W when the power module leaves the bi-level tank to begin another duty cycle.

From a technical perspective, as a power module enters the bi-level tank, the transfer of a motive force between W and B is best understood by first considering the work/energy relationship of the power module during the DOWN portion of its duty cycle. This will then be followed by a consideration of the impulse/momentum relationship in the UP portion of the duty cycle.

To begin the DOWN portion, the power module is dropped from a predetermined height and it accelerates to an engagement velocity, vₑ. Thus, the power module will have a velocity vₑ when it engages with an electric generator. While engaged with the electric generator the engagement velocity vₑ of the power module remains constant (i.e. it is in a steady state). In this steady state, the power module generates a kinetic energy equal to ½ mvₑ², which is used to drive the electric generator. At the end of this power engagement, the power module disengages from the electric generator and immediately enters the bi-level tank. Importantly, after disengagement from the electric generator, the power module will start with an energy of ½ mvₑ².

An important aspect of the power module's duty cycle is that, as it enters the bi-level tank, the power module encounters water which is subject only to atmospheric pressure. By way of example, this situation is the same as if the power module were being dropped into a swimming pool. In the event, although the power module is buoyant, it will still have an energy of ½ mvₑ² as it enters the bi-level tank. Thus, using the mass in (i.e. weight W) of the power module and its velocity vₑ as design criteria, the power module can be engineered for its energy ½ mvₑ² to do the work that is needed for it to dive and submerge into the bi-level tank.

As the power module enters the bi-level tank, due to the change in density of the media in which the power module travels, there will be a substantial increase in the buoyancy force B acting on the power module. Additionally, together with the buoyancy force B, a significant drag force D also begins to act on the power module. Further, both the buoyancy force B and the drag force D will act on the power module to oppose the weight W of the power module. Consequently, the power module initially decelerates in the bi-level tank until its velocity v is equal to zero. At the point where v becomes zero, the power module will begin to rise in the bi-level tank under the influence of its buoyancy B. For the present invention, it is important to recognize that the forces W, B and D can all be collectively engineered to optimize the deceleration of the power module in the bi-level tank.

At the point in its duty cycle where the power module has decelerated to zero velocity in the bi-level tank, the buoyancy force B will immediately dominate and cause the power module to begin rising (i.e. 8>W), A simple example of this sink/rise phenomenon can be demonstrated by dropping ice into a glass of water.

Like the ice dropped into a glass of water, both the buoyancy force B and the weight W of the power module will remain constant. As the power module rises in the bi-level tank, however, the drag force D will begin to increase as a function of the power module's velocity squared, v². As the power module rises in the bi-level tank during the UP portion of the duty cycle, the drag force D will act together with the weight W of the power module to oppose movement of the power module as it rises in the bi-level tank.

Movements of the power module in the bi-level tank are directly influenced by the drag forces D that act on the power module. It happens that the engineered design for coefficients of drag C_{D} of the power module will influence the effect these drag forces D have on the velocities of the power module as it travels in the bi-level tank, Simply stated, C_{D} is an engineering consideration.

For an operational perspective, it is necessary to know that the power module remains essentially upright in the bi-level tank as it decelerates at the end of the DOWN portion of a duty cycle, and also as it rises during the UP portion of the duty cycle. Consequently, a coefficient of drag C_{D(lower)} for the lower end of the power module can be engineered to maximize its deceleration upon entering the bi-level tank. Furthermore, a coefficient of drag C_{D(upper)} can be separately engineered for its upper end to maximize acceleration of the power module during its rise in the bi-level tank. In their relation to each other, C_{D(lower)} is preferably greater than C_{D(upper)}.

An important design consideration for C_{D(lower)} is that the power module must be able to submerge into the bi-level tank and then decelerate to zero velocity as soon as practicable. On the other hand, the important design consideration for C_{D(upper)} is that the power module must attain its terminal velocity vₜ, before it exits from the bi-level tank. The terminal velocity vₜ is an important design consideration because vₜ and the mass m of the power module determine the momentum, mvₜ, that will be required for the power module to exit the bi-level tank at the end of a duty cycle.

At the top of the bi-level tank, the UP portion of the duty cycle is completed. Also, at this point the motive force on the power module will revert from B back to W. Further, the power module will have a zero velocity v, at least momentarily, before it begins another DOWN portion in the next duty cycle.

### SUMMARY OF THE INVENTION (STRUCTURE)

The base component for a machine of the present invention is a bi-level tank. As its nomenclature implies, its purpose is to hold a body of water that will have both an upper level water surface and a lower level water surface. To do this, a valve mechanism is incorporated into the bi-level tank that includes two separate, interactive valves. Alternately, the separate valves perform a changeover operation where they are either open/closed or closed/open. With these conditions, the valve mechanism will either isolate the upper water surface from the lower water surface, or it will establish an unobstructed underwater pathway through the bi-level tank.

Structurally, the bi-level tank includes both a lower transfer tank and an upper return tank. In this combination, the return tank is mounted above the transfer tank, and a transfer port is established between the two tanks. Thus, fluid communication between the upper return tank and the lower transfer tank will depend on whether the transfer port is open or closed by the valve mechanism. In addition to the transfer port between the return tank and the transfer tank, the transfer tank also has a separate access port.

A cooperative interaction between the transfer port and the access port is clearly necessary for the machine's operation. When the transfer port is open, an unobstructed underwater pathway is created through the bi-level tank that continues from the transfer tank and into the return tank. For this configuration of the bi-level tank, the access port must be closed. However, when the transfer port is closed, the transfer tank is isolated from the return tank and the access port can be opened.

Regardless whether the transfer port is open or closed, the upper level water surface of the return tank will always remain exposed to only the atmosphere. As noted above, however, when the transfer port is open, the access port must be closed. With this configuration for the bi-level tank, the return tank will be in fluid communication with the transfer tank and water pressure in the transfer tank will thereby be elevated under the influence of water in the return tank. On the other hand, when the transfer port is closed, the transfer tank is isolated from the return tank and the access port into the transfer tank is opened. For this configuration of the bi-level tank, the lower level water surface in the transfer tank will be exposed to only atmospheric pressure.

In addition to the bi-level tank, and the valve mechanism, the machine of the present invention also includes a buoyant power module. As noted above, the power module is dropped from a start point at an elevated height to start a duty cycle. At first, the power module falls through air and engages with an electric generator. Subsequently, when it disengages from the electric generator, the power module dives (plunges) into the transfer tank of the bi-level tank. The power module then proceeds through the transfer tank, and into the return tank along an unobstructed underwater pathway for a return to the duty cycle start point.

In accordance with an operation of the valve mechanism, an unobstructed underwater pathway through the bi-level tank is periodic. Moreover, in cooperation with an operation of the valve mechanism, the temporary presence of a power module in the transfer tank must be accounted for during an operation of the machine. Consequently, in order to accommodate the travel of a continuing succession of power modules along an unobstructed underwater pathway through the bi-level tank, the present invention incorporates a displacement device.

The displacement device of the present invention is submerged in the transfer tank of the bi-level tank, and it is cyclically operated in cooperation with the valve mechanism to compensate for the temporary presence of a power module passing through the transfer tank. The displacement device does this by first displacing a volume of water from the transfer tank. Specifically, this is done by pushing water from the transfer tank through the transfer port and into the return tank. At this time there is an unobstructed underwater pathway in the bi-level tank, and a power module is in the transfer tank. Note: as the power module is leaving the transfer tank and is entering the return tank, a volume of water leaves the return tank and reenters the transfer tank. After the power module has departed the transfer tank, the valve mechanism is operated to again obstruct the water pathway, and the displacement device is operated to recover a volume of air V_{d} into the transfer tank through the access port. In this exchange, the volume of water displaced into the return tank by the displacement device, and the volume of air V_{d} recovered into the transfer tank by the displacement device are equal to the volume of a power module. Thus, water in the bi-level tank is moved back and forth between the transfer tank and the return tank to account for the passage of one power module through the transfer tank, and to accommodate the next power module in sequence. This is done with no loss of water from the bi-level tank. An important consequence of this is that the difference between respective levels of the upper and lower water surfaces is maintained.

A control unit is provided for the machine that will coordinate an operation of the valve mechanism with an operation of the displacement device as disclosed above. This requires external power from an available source. As envisioned for the present invention, the external power source will preferably be a commercial power grid. However, the electric generator that is driven by the machine of the present invention may itself be used as an alternative power source. In either case, an external source of power will be required to operate power-driven components of the machine, and to account for friction losses.

Ancillary components of the bi-level tank include a deflector/exit chute and a launch platform. Specifically, the deflector/exit chute is located at the top of the return tank and is used to reorient a power module as it exits the return tank. In the return tank, most of the closed-loop underwater pathway traveled by the power module needs to be vertically oriented. This vertical orientation, however, is inefficient for recovering a power module at the end of a duty cycle. For this reason, the deflector/exit chute is oriented to establish an exit angle ϕ from vertical so that the exit momentum of a power module will be directed toward a launch platform as it emerges from the return tank. The exit angle ϕ will preferably be in a range between 15°-20°.

In its relationship with the bi-level tank, the launch platform is positioned near the deflector/exit chute to receive a power module as it emerges from the return tank. In its relationship with the duty cycle of a power module, the launch platform is at the start point. Structurally, the launch platform is formed to receive, stabilize and hold the power module in a predetermined, near-horizontal, orientation on the launch platform. This orientation is then held until the power module is to be released to begin another duty cycle. For this purpose, the launch platform also includes a rotating mechanism that is power activated to rotate the launch platform and thereby release (i.e. drop) the power module, Upon its release from the launch platform it is important that the power module be in a vertical, upright orientation for subsequent engagement with the electric generator.

With a specific consideration now directed to the power module, it is important that the power module be buoyant, but that it also have the weight needed to do the work necessary to drive an electric generator (i.e. ½ mvₑ²). Within these constraints, weight W and buoyancy B are both forces that are continuously acting on a power module. Although W is constant, the buoyancy force B will change in both magnitude and direction during a duty cycle of a power module. Also, when a power module is moving, there will be a drag force D acting on the power module whose magnitude will depend on the velocity v of the power module. Accordingly, these interrelated forces require scrutiny.

By definition, weight W is the force acting on an object of mass m in the gravitational field. Weight is a constant and it is not affected by movements of the object. Moreover, weight always acts on an object in a downward direction toward the center of the earth. On the other hand, buoyancy is defined as the ability or tendency of an object to float in water or any other fluid. For objects in the earth's atmosphere (i.e. air), the buoyant force on heavier-than-air objects is typically ignored. This is not the case, however, when the object is submerged in water.

In general, there are several aspects of a buoyant force (B) that are particularly noteworthy. For one, the magnitude of a buoyant force is determined by the difference between the volume-weight (i.e. weight/volume) of an object, and the volume-weight of the fluid medium (e.g. water) that is displaced when the object is submerged in the fluid medium. Using the respective magnitude of B and W, a buoyancy factor can be determined. Mathematically, the buoyancy factor is a dimensionless ratio of the buoyant force (B) to the weight (W) of the object (i.e. the buoyancy factor=B/W). For this ratio the volume of the object and the volume of the displaced fluid medium (e.g. water) are equal. It is important to note that for the buoyancy factor, the density of the materials that are used for the manufacture of the object, and the shape of the object, are not factors in determining the object's buoyancy. Succinctly stated, it is only the volume of the object that matters.

The power module of the present invention is buoyant because it is engineered to be lighter than the volume of water it displaces in the bi-level tank. Thus, the materials used to provide strength and form for the power module are engineering design considerations. Preferably, the power module is designed to establish a buoyancy ratio (B/W), in water, that is in a range between 0.6 and 0.75.

As indicated above, whenever a power module moves, drag forces act to oppose the movement of the power module. Mathematically, a drag force D is expressed as:

Drag=D=C_{D}½ρv²S

In this equation, C_{D} is a dimensionless coefficient, ρ is the density of the medium, v is the velocity of the object in the medium, and S is a function of the object's shape and cross-sectional area. The import here is that the drag force D is dependent on medium density, object velocity, and the design shape of the object. In the context of the present invention, the respective drag coefficients C_{D(upper)} and C_{D(lower)} have been discussed above with regard to the engineering effect they can have on movements of a power module through a bi-level tank.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a machine for the present invention;

FIG. 2A is a cross-section view of the machine as seen along the line 2-2 in FIG. 1, when the machine is configured to receive a power module;

FIG. 2B is a view of the machine as shown in FIG. 2A when the machine is configured to reorient the power module in the transfer tank of the present invention;

FIG. 2C is a view of the machine as shown in FIG. 2A after the power module has passed through the transfer tank and the transfer tank has been reconfigured to receive the next successive power module;

FIG. 3A is a cross-section view of a displacement device for use with the present invention, with the displacement device shown in a deactivated configuration;

FIG. 3B is a view of the displacement device as shown in FIG. 3A, with the displacement device in an activated configuration;

FIG. 4A is a perspective view of a power module in accordance with the present invention;

FIG. 4B is a cross-section view of the power module as seen along the line 4B-4B in FIG. 4A;

FIG. 5 is a cross-section view of the machine of the present invention showing a positioning of velocity and hydrodynamic sensors on the machine;

FIG. 6 is a table showing the correlation between a functional operation of the machine and the changeover operation of the valve mechanism of the present invention;

FIG. 7 is a velocity profile for a single power module during a duty cycle in accordance with an operation of the machine wherein four power modules are used, with a corresponding reference for each successive three power modules identified relative to the first power module; and

FIG. 8 is a diagram of interconnected components required for operating and controlling an operation of the present invention.

### DESCRIPTION OF THE PREFERRED EMBODIMENTS

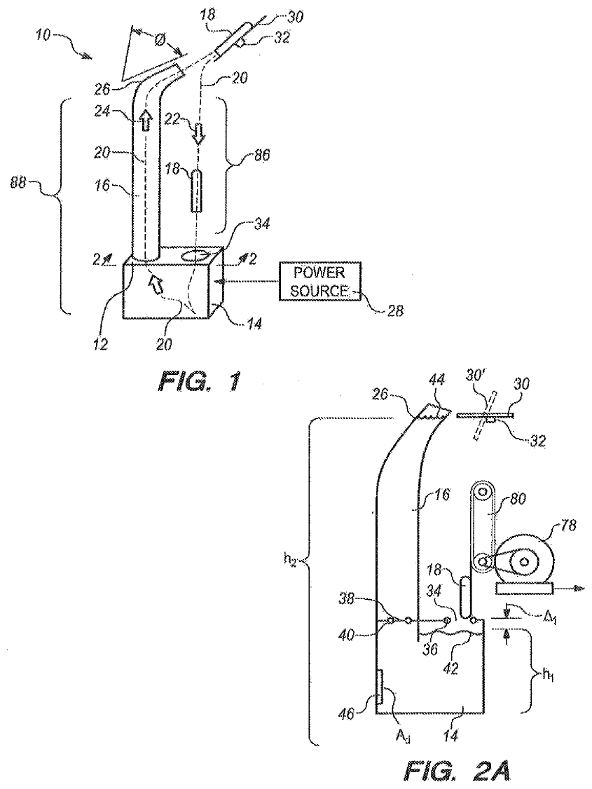

Referring initially to FIG. 1, a machine in accordance with the present invention is shown and is generally designated 10, As shown, the machine 10 includes a bi-level tank 12 that has a both a lower transfer tank 14 and an upper return tank 16. The operational purpose of the machine 10 is to move a power module 18 through a duty cycle on a closed-loop pathway 20 which is generally designated by the dashed line 20 in FIG. 1. Further, as shown in FIG. 1, a duty cycle on closed-loop pathway 20 includes a DOWN portion, indicated by the arrow 22, and an UP portion, indicated by the arrow 24. FIG. 1 also shows that the machine 10 includes a deflector/exit chute 26 that is connected to the top of the return tank 16 for directing the power module 18 as it leaves the bi-level tank 12. As will be appreciated with the additional disclosure presented below, an important consideration for the machine 10 is that it requires an external power source 28 for its operation. As envisioned for the present invention, the external power source 28 can be any such source well known in the art, such as a power grid provided by a commercial power company or some other external generator.

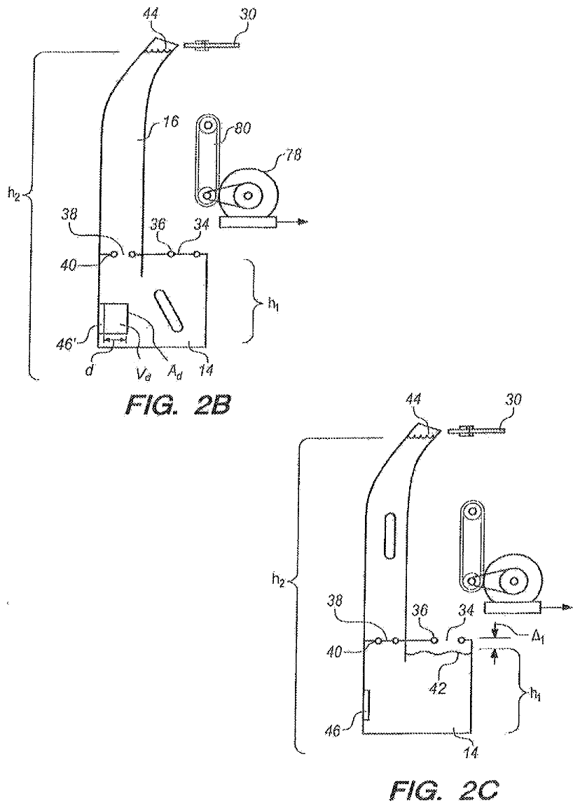

Additional aspects of the bi-level tank 12 will be appreciated with reference to FIG. 2A. In FIG. 2A a launch platform 30 is shown positioned above the transfer tank 14 at a location near the deflector/exit chute 26 of the return tank 16. At this location, the launch platform 30 is positioned to receive a power module 16 as it exits from the return tank 16 through the deflector/exit chute 26 at the end of a duty cycle. Further, it is shown that a rotating mechanism 32 is provided for the launch platform 30. In detail, when a power module 18 is received by the launch platform 30, it will be held on the launch platform 30 until the rotating mechanism 32 is activated to move the launch platform to an orientation indicated for launch platform 30′. The power module 18 will then be dropped from the launch platform 30′. After a power module 18 has been dropped, the orientation for launch platform 30 is reassumed to receive the next power module 18 in sequence. It is to be noted that an operation of the launch platform 30 requires power from the external power source 28.

Still referring to FIG. 2A, it will be seen that the transfer tank includes an access port 34 which can be closed or opened by an access valve 36. Also, a transfer port 38 is located between the transfer tank 14 and the return tank 16 which can be closed or opened by a transfer valve 40. Because the access valve 36 and the transfer valve 40 must perform a changeover operation with each other, the valves are sometimes referred to, collectively in this disclosure, as a valve mechanism 36/40.

An operation of the valve mechanism 36/40, and its import for an operation of the machine 10, will be best appreciated with a successive consideration of FIGS. 2A, 2B and 2C. In FIG. 2A, it will be noted that the valve mechanism 36/40 is configured so that the access port 34 is open and the transfer port 38 is closed. With this configuration for the valve mechanism 36/40, the transfer tank 14 is isolated from the return tank 16 and there is no fluid communication between water in the transfer tank 14 and water in the return tank 16. Also, the water surface 42 in the transfer tank 14 is exposed to only the atmosphere. The consequence of this configuration is that a power module 16 can enter the transfer tank 14 through the open access port 34. Moreover, the kinetic energy of the power module 18 (½ mv²) must only do work against an exposed water surface 42 that experiences a head height h₁, which is directly influenced by only the atmosphere.

In FIG. 2B the valve mechanism 36/40 is shown configured with the access port 34 closed and the transfer port 38 open. With this configuration for the valve mechanism 36/40, the transfer tank 14 is opened to the return tank 16. This establishes an unobstructed underwater pathway 20 from the transfer tank 14, through the return tank 16, and up to the atmospherically exposed water surface 44 of the return tank 16. At this point however, although water in the transfer tank 14 is subjected to an increased head height h₂, it is to be appreciated there is no adverse operational effect on the power module 18. Note: in their relationship to each other h₂>>h₁.

For the next successive configuration for the valve mechanism 36/40, FIG. 2C shows that the access port 34 has been reopened and the transfer port 38 has been reclosed. This changeover operation puts the bi-level tank 12 back into a configuration for receiving a next module 18 into the transfer tank 14. In accordance with the present invention, the successive configurations of valve mechanism 36/40 are repeated for each duty cycle of the power module 18.

As disclosed above, the valve mechanism 36/40 is provided for the purpose of maintaining different levels for the water surface 42 and the water surface 44 in the bi-level tank 12, Insofar as the actual operation of a valve mechanism 36/40 is concerned, this operation merely needs to changeover the open and closed condition of the access port 34 and the transfer port 38 in the bi-level tank 12. For this purpose, the selection of a specific type valve mechanism 36/40 for each machine 10 will depend on the operational requirements of the machine 10 that is being constructed (e.g. structural strength required, size, timing and output power requirements). Thus, although many valve types can be considered for use with the machine 10, the selection of a particular valve type for the valve mechanism 36/40 is a design and engineering consideration that can, and often will, require an evaluation of many different types of valves; to include: globe valves, butterfly valves, gate valves, slide valves, ball valves, check valves, diaphragm valves, plug valves and pinch valves.

In general, the operation of a displacement device 46 in accordance with the present invention will be best appreciated with reference to FIGS. 2B and 2C. In FIG. 2B, the bi-level tank 12 is shown configured after a power module 18 has entered the transfer tank 14. Specifically, for this configuration the access port 34 is closed and the transfer port 38 is open. At this point in a duty cycle, the water pathway 20 from the transfer tank 14 into the return tank 16 is unobstructed by the transfer valve 40 at the transfer port 38. It is also important to recognize that in FIG. 2B, the displacement device 46′ has been activated while the power module 18 is in the transfer tank 14.

Structurally, the activated displacement device 46′ occupies a displacement volume V_{d} in the transfer tank 14 that is equal to the volume Vₘ, of the power module 18 (V_{d} Vₘ). To establish this relationship, a surface 48 of the displacement device 46, having a flat projection displacement area A_{d}, has been moved into the transfer tank 14 through a displacement distance d (i.e. V_{d}=A_{d}d). The result here is that in addition to the presence of a power module 18 of volume Vₘ in the transfer tank 14, a volume of water equal to A_{d}d (i.e. V_{d}) has been displaced from the transfer tank 14 and moved into the return tank 16. Recall V_{d} Vₘ. Therefore the total water displaced from the transfer tank 14 for the configuration of the bi-level tank 12 shown in FIG. 2B, is V_{d}+Vₘ=2Vₘ.

In FIG. 2C, it will be seen that the power module 18 has progressed from the transfer tank 14 and into the return tank 16. Also, the displacement device 46 has been deactivated to remove a volume V_{d} of water from the transfer tank 14. The configuration of the bi-level tank 12 has also been changed to open the access port 34 and close the transfer port 38. The consequence of this is that the power module volume Vₘ has moved into the return tank 16. Also, the displacement volume V_{d} has been removed by a deactivated displacement device 46 to recover a volume of air V_{d} into the transfer tank 14 that is equal to Vₘ. The result here is that the bi-level tank 12 has been reconfigured to receive the next successive power module 18 (see FIG. 2A).

As envisioned for the present invention, a displacement device 46 can have any one of several different structures. Accordingly, each structure will have correspondingly different components. It is possible that the displacement device 46 may be either pneumatically activated, mechanically activated or activated by a structure that requires both pneumatic and mechanical activation. For instance, as a pneumatic device, the displacement device 46 may employ compressed air to operate pressurized bellows or an inflatable bladder. On the other hand, for a mechanical device the displacement device 46 may employ a piston component that is activated by an electromagnetic drive, an electric drive or a mechanical drive. Stated differently, the present invention recognizes the possibility that different drive components may be employed to operate a displacement device 46 for the purposes of the present invention. In any case, it is necessary for the displacement device 46 to first displace a volume of water V_{d} from the transfer tank 14 as disclosed above. Then, the displacement device 46 needs to be timely activated in cooperation with the valve mechanism 36/40 to recover a same volume of air V_{d} into the transfer tank 14, as also disclosed above.

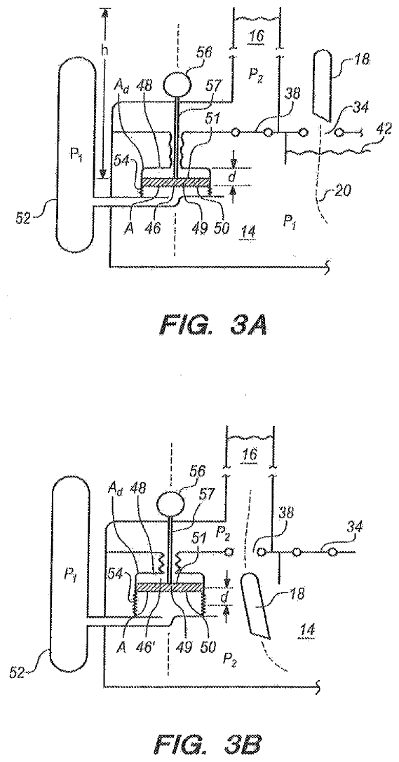

With reference to FIGS. 3A and 3B, a displacement device 46 is shown submerged in the transfer tank 14, with a configuration wherein it is deactivated. As shown, the displacement device 46 has an outside upper surface 46, and it includes a piston 49 with a lower surface 50 and an inside upper surface 51. Also, FIG. 3A indicates that the lower surface 50 of the piston 49 has a surface area A that is in fluid communication with a pressure tank 52 which holds compressed air at a pressure p₁. Thus, the lower surface 50 of the piston 49 will continuously be subject to a pressure of approximately p₁ that exerts a force equal to p₁A on the lower surface 50. Further, FIG. 3A indicates that the inside upper surface 51 of the piston 49 is in fluid communication with the return tank 16 and it will thereby be continuously subject to a pressure p₂.

Still referring to FIG. 3A, it is seen that a concertina skirt 54 surrounds the lower surface 50 of the displacement device 46. The concertina skirt 54 also interconnects the displacement device 46 with the pressure tank 52. Further, the displacement device 46 is shown to be mechanically connected directly to a force actuator 56, that is external to the transfer tank 14.

At this point in the duty cycle of a power module 18, in order to displace a volume of water V_{d} from the transfer tank 14, and to move it into the return tank 16, the outside upper surface 48 of the displacement device 46 must act against the water pressure p₂ that is caused by the head height h; in the transfer tank 14. In this case, the work required to displace V_{d} will be equal to the product of the projected displacement area A_{d} for the upper surface 48 of the displacement device 46, the pressure p₂ in the return tank 14, and the displacement distance d that is required for a movement of the displacement device 46 to create a volume V_{d} (i.e. A_{d}p₂d).

In a preferred embodiment for the displacement device 46, fluid pressure p₁ from pressure tank 52 is established in fluid communication with the lower surface 50 of the piston 49 of the displacement device 46. This pressure p₁ on the lower surface 50 of piston 49 will act directly against the area A of the lower surface 50 and thereby create a biasing force Ap₁. This biasing force Ap₁ will then directly oppose the force A_{d}p₂ that acts against the upper surface 48 of the displacement device 46. Recall, the inside upper surface 51 of the piston 49 will also be subject to the pressure p₂. Thus, a structure is created where the only pressure forces acting on the displacement device are p₁ and p₂. Within this structural combination, the pressure p₂ that is due to head height h₂ in the return tank 16 and the pressure p₁ from the pressure tank 52 can be respectively used to create a pressure differential Δp=p₂−p₁, wherein p₂>p₁. Thus, a force that is proportional to Δp will always act against the displacement device 46 to urge the displacement device 46 into its deactivated configuration. It is also to be appreciated that other devices can be used to create the bias force. For instance, instead of using compressed air, a spring can be used with an appropriate spring constant to establish Δp. Further, the use of a counteracting water column is possible. For example, water pressure from the return tank 16 can be directed against the lower surface 50 of the piston 49 to create Δp.

In any event, it is important that the bias force create a Δp that is relatively small, e.g. in a range between 1.5 and 2 psi. Accordingly, an activating force from the force actuator 56 that will raise the displacement device 46 through a distance d, against the force A_{d}p₂d that is caused by water in the transfer tank 14, need only be greater than A_{d}Δp. Preferably, the force actuator 56 will be a motorized winch-type motor that is connected by a cable 57 with the inside upper surface 51 of the piston 49.

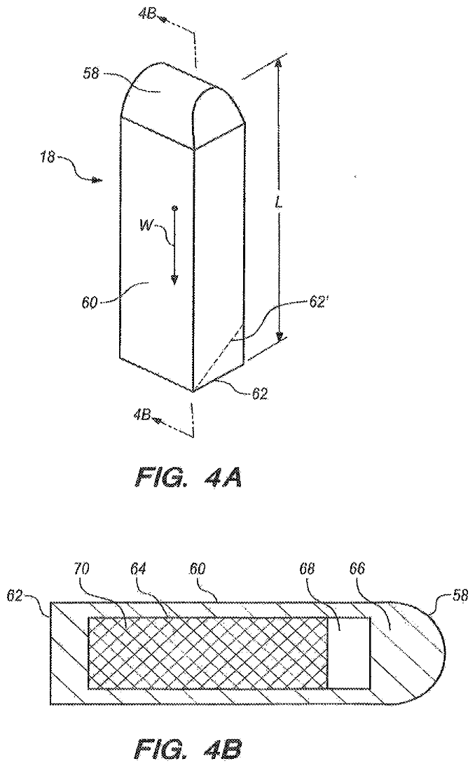

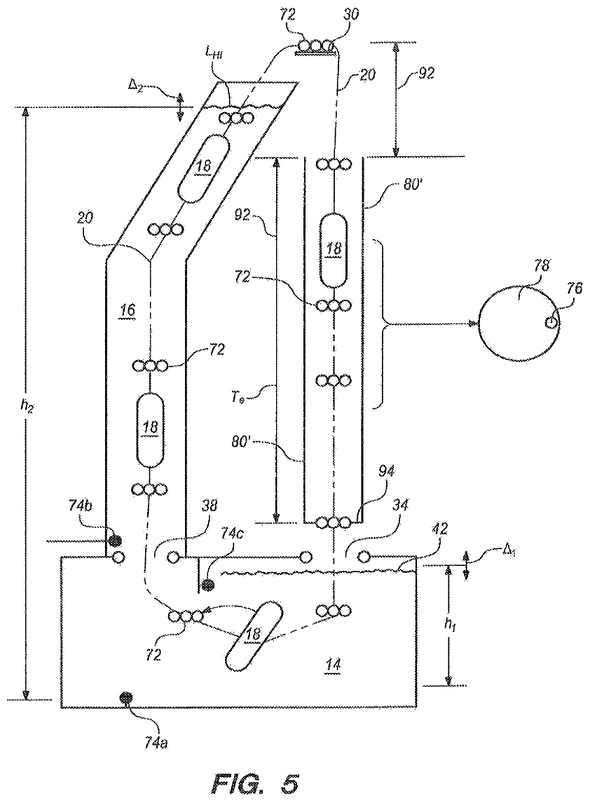

The power module 18 shown in FIGS. 4A and 4B is exemplary of a preferred structure for the power module 18 of the present invention. As shown, the power module 18 has an upper end 58, a body 60 and a lower end 62. Further, FIG. 4A shows that the lower end 62 can be modified for hydrodynamic purposes, such as by being slanted as shown by the dashed line for the lower end 62′. Depending on engineering design considerations, the length L of the power module 18 can be varied. Operationally, recall the power module 18 remains upright, i.e. with the upper end 58 remains above the lower end 62, during an entire duty cycle of the power module 18.

FIG. 4B, shows that the interior of a power module 18 will include an enclosed chamber 64 that is surrounded by a structure 66. This structure 66 will preferably be a strong heavy material, such as a metal, that is formed to create the exterior surface of the power module 18. For purposes of the present invention, the power module 18 will have weight W and a volume Vₘ.

As emphasized above, it is an important design consideration for the present invention that the power module 18 be buoyant. For this consideration, the weight W and the volume Vₘ are constant, and are predetermined. Thus, the buoyancy of the power module 18 must consider the weight that is added by components put into the chamber 64. For instance, it is envisioned that the chamber 64 will include a compartment 68 for holding electronics (e.g. sensors) and possibly magnets (not shown). Also, if necessary, materials including a support grid 70 can be erected in the interior of the chamber 64 for added strength and rigidity. In any event, as disclosed above, the power module 18 must be buoyant, and have a buoyancy factor that is preferably in a range between 0.6 and 0.75.

In accordance with above disclosure, and with reference to FIG. 5, it will be appreciated that an operation of the present invention requires precise velocity control over each power module 18 during its duty cycle. Preferably, by way of example, the present invention will involve a multi-module machine 10 that simultaneously uses four power modules 18. For purposes of the present invention, a plurality of position/velocity control sensors 72 are variously mounted on the machine 10. Additionally, a plurality of hydrodynamic sensors 74 are submerged in the bi-level tank 12. Further, FIG. 5 shows that an output power gauge 76 is mounted on an electric generator 78 that is connected with a linear drive component 80. As envisioned for the present invention, the linear drive component 80 may be either a mechanical chain drive, as show in FIGS. 2A-C, or it can be an electro-magnetic solenoid 80′, as shown in FIG. 5. With either structure, it is important that the power module 18 be securely engaged with the linear drive component 80/80′ as its kinetic energy is used to drive the electric generator 78.

The plurality of position/velocity sensors 72 are specifically located on the machine 10 to measure positions and velocities of each power module 18 as it passes selected points in the bi-level tank 12 during its respective duty cycle. Preferably, at least one position/velocity sensor 72 is positioned at the launch platform 30 to determine when a power module 18 is ready for launch. At least one position/velocity sensor 72 is located on the DOWN portion of the closed-loop pathway 20 to monitor the velocity vₑ of power modules 18 while they are driving the electric generator 78 by their engagement with a linear drive component 80 for the electric generator 78.

Also, a plurality of position/velocity sensors 72 are positioned in the bi-level tank 12. More specifically, position/velocity sensors 72 are positioned in the transfer tank 14 to monitor the transfer of a power module 18 from the transfer tank 14 into the return tank 16, Further, position/velocity sensors 72 are positioned in the return tank 16 to ensure appropriate duty cycle locations for power modules 18 on the UP portion of the closed-loop pathway 20 in preparation for a subsequent exit from the return tank 16.

The plurality of hydrodynamic sensors 74 are submerged in the bi-level tank 12 to measure fluid characteristics of the liquid in the bi-level tank 12. In particular, at least one hydrodynamic sensor 74a records fluid pressure in the transfer tank 14 when the access port 34 is open and the transfer port 38 is closed. At least one other hydrodynamic sensor 74b records fluid pressure in the transfer tank 14 when the access port 34 is closed and the transfer port 38 is open. And, at least one hydrodynamic sensor 74c records fluid pressure in the transfer tank 14 to monitor variations Δ₁ in the lower level water surface 42 of the transfer tank 14. The general purpose here is to provide hydrodynamic values that can affect the velocity of a power module 18 in the bi-level tank 12, and to provide information to a control unit 82 (see FIG. 8) pertaining to the level of the lower water surface 42 and the level of the upper water surface 44 together with their respective variations Δ₁ and Δ₂ that are needed for a timely operation of the valve mechanism 36/40. Additionally, the hydrodynamic sensors 74 in the transfer tank 14 provide important information to the control unit 82 regarding fluid pressure values in the transfer tank 14 that must be accounted for during a proper operation of the displacement device 46.

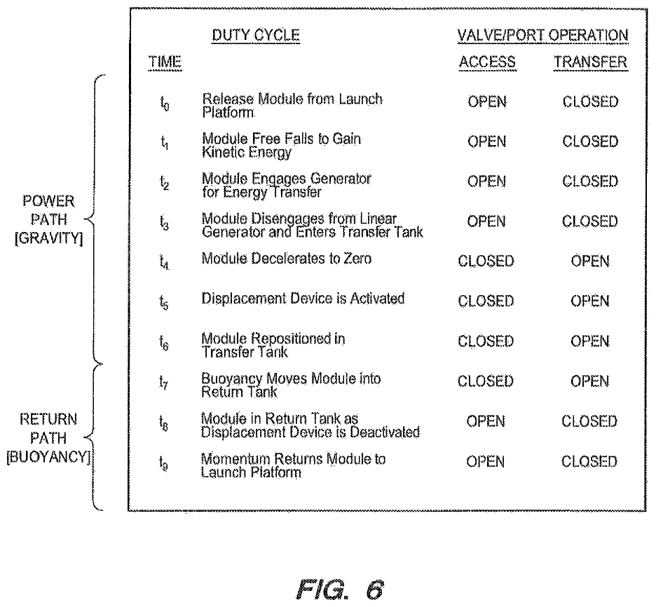

With reference to FIG. 6, the required operation of the valve mechanism 36/40 with the operation of the displacement device 46 is provided for reference purposes. Specifically, FIG. 6 correlates a functional operation of the machine 10 with the changeover required for an operation of the valve mechanism 36/40, and the corresponding configurations of the access port 34 and the transfer port 38. As disclosed above, a valve mechanism 36/40 is provided for the purpose of maintaining different liquid surface levels in the bi-level tank 12. On the other hand, the displacement device 46 is required to accommodate the passage of a power module 18 through the transfer tank 14. Also, it is to be recalled that the displacement device 46 is activated when the access port 34 is closed and the transfer port 38 is open. Furthermore, the displacement device 46 is deactivated when the access port 34 is open and the transfer port 38 is closed.

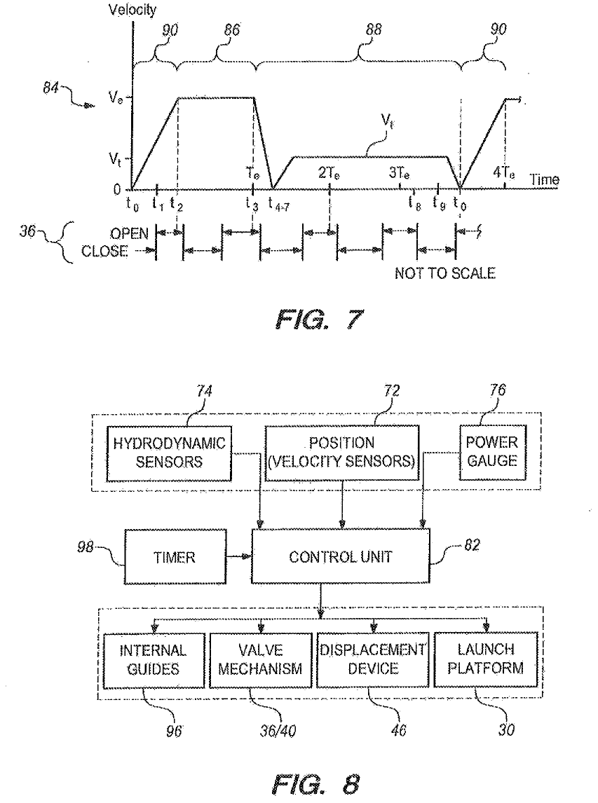

Operational control for the machine 10 will be best appreciated with reference to FIG. 7, where the velocity profile of an exemplary duty cycle 84 for one power module 18 is presented. FIG. 7, shows this duty cycle 84 in a context with the operation of the valve mechanism 36/40. Recall, when access valve 36 is open, transfer valve 40 will be closed and vice versa. Moreover, in FIG. 7, the duty cycle 84 for a single power module 18 is shown in a relation of its engagement time Tₑ with the electric generator 78 and the engagement times 2-4 Tₑ for three additional power modules 18.

With reference to the timeline in FIG. 7, it is to be appreciated that a duty cycle 84 can be considered as extending from t₀ to t₀. In this case, the engagement time Tₑ (see FIG. 5) will extend from t₂ to t₃. For a four-module machine 10, as shown in FIG. 5, a complete duty cycle 84 for each power module 18 will have a duration equal to 4 Tₑ.

With the above in mind, the positions and velocities of each power module 18 as it travels through a duty cycle 84 must necessarily be based on Tₑ. Also, as discussed above, there are two velocities in a duty cycle 84 that will remain substantially constant. First, the engagement velocity Vₑ that a power module 18 has during a power phase 86 (see FIG. 1) of the duty cycle 84 needs to be constant during the time Tₑ. Specifically, Vₑ is constant while the power module 18 is engaged with the linear drive component 80 of the electric generator 78. Second, the velocity vₜ which is the terminal velocity attained by the power module 18 as it rises in the return tank 16, during a return phase 88 of the duty cycle 84, will remain constant. Module velocities other than vₑ and vₜ are transitional velocities which will either accelerate to vₑ or vₜ; or decelerate from vₑ or vₜ to zero.

FIG. 7 shows that from the time t₀ when a power module 18 is dropped for free fall 90 from the launch platform 30 until it engages with the linear drive component 80 at time t₂, the velocity of a power module 18 increases from zero to vₑ. For the present invention, vₑ will depend on the weight W of a power module 18, as well as the free fall distance 92 (see FIG. 5). Importantly, vₑ for a power module 18 is established so it will generate the voltage and sine wave characteristics that are required by the end user (e.g. a commercial grid). Operationally, vₑ can be controlled by control unit 82 using output from power gauge 76 to determine appropriate loading for the linear drive component 80.

As shown, vₑ is held constant between t₂ and t₃ for a time interval Tₑ. Note: at the time t₃, as a power module 18 disengages from the linear drive component 80, the next successive power module 18 will simultaneously engage with the linear drive component 80. Also, it is important to note that at the time t₃, the access port 34 will be open to allow the disengaged power module 18 to enter the transfer tank 14. At this time, the transfer port 38 will accordingly be closed. As a safety feature, in order to ensure that access port 34 is indeed open, a mechanical trip switch 94 (see FIG. 5) can be provided at a predetermined distance above the access port 34. Shortly after t₃, however, i.e. once the power module 16 has entered the transfer tank 14, access port 34 immediately closes.

Once the power module 18 is in the transfer tank 14, the displacement device 46 is activated to force a volume of liquid V_{d} from the transfer tank 14, through the now-open transfer port 38. Specifically, as noted elsewhere herein, this displaced volume V_{d} of liquid will be equal to the volume Vₘ of the power module 18 that is in the transfer tank 14 at the time.

While it is inside the transfer tank 14, the power module 18 will decelerate to zero (v=0). Then, as it is being reoriented in the transfer tank 14, the power module 18 will accelerate to its terminal velocity vₜ as it transitions from the transfer tank 14 and into the return tank 16. It is important that the power module 18 leave the transfer tank 14 within the time interval Tₑ so the next power module 18 will be able to enter the transfer tank 14 during its respective duty cycle 84.

Still referring to FIG. 7 it will be appreciated that a power module 18 will maintain its terminal velocity vₜ in the return tank 16 until it exits from the return tank 16. Before starting its next duty cycle 84, the power module 18 will decelerate from v to zero. Deceleration is then complete when the power module 18 is repositioned on the launch platform 30 to begin its next duty cycle 84 with another free fall 90.

Recall, with reference to FIG. 7, the above disclosure has been described in terms of a duty cycle 84 for only one power module 18. As has been noted, however, for an operation that involves a plurality of power modules 18 (e.g. four), each power module 18 will experience a same duty cycle 84. Moreover, each power module 18 will be engaged with the linear drive component 80 for a same time interval Tₑ. Thus, in this example the time duration of the duty cycle 84 for each power module 18 will be 4 Tₑ.

As envisioned for the present invention, it may be desirable for there to be a plurality of power modules 18 concurrently engaged with the linear drive component 80. In this case, the time each power module 18 is reoriented in the transfer tank 14 will necessarily be shortened since there can only be one power module 18 at a time in the transfer tank 14.

Another consideration for the structure of a machine 10 is the incorporation of internal guides 96 that are referred to in FIG. 8. These guides can be positioned along the closed-loop pathway 20 to establish and maintain a controlled movement of the power module 18 through the machine 10 to include engagement with the electric generator 78 and a reorientation of the power module 18 in the transfer tank 14. For this purpose, internal guides 96 can be positioned along the portion of closed-loop pathway 20 where power modules 18 engage with the linear drive component 80 of electric generator 78. Internal guides 96 can also be appropriately positioned in the bi-level tank 12. The particular structures used for internal guides 96 will depend primarily on engineering design criteria, the size and shape of power modules 18, and the operational requirements for a machine 10. With this in mind, internal guides 96 will typically be rollers, rails, bulkheads, barriers, restraints, magnets, or a combination of these various structures.

Referring now to FIG. 8, it will be seen that the control unit 82 is connected in electronic communication with a timer 98 and with other electronic and mechanical components of the machine 10. Specifically, the control unit 82 uses the timer 98 to coordinate the operation of the various system components. In particular, these components include the launch platform 30, the displacement device 46 and the valve mechanism 36/40. They also include the internal guides 96 that assist in keeping power modules 18 on the closed-loop pathway 20 during a duty cycle 84.

While the particular Machine for Driving an Electric Generator as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

1-20. (canceled)

21. Apparatus, comprising:
a confined volume of water comprising a transfer component defining a lower water surface and a return component extending upright from the transfer component to an upper water surface above the lower water surface, an open access port over the lower water surface, and a closed transfer port isolating the return component from the transfer component;
an electric generator between the open access port and a power module supported by a launcher proximate to the upper water surface, the launcher configured to move into and out of a launching position for releasing the power module from the launcher, the power module configured to fall by gravity from the launcher into the transfer component through the open access port and by being sufficiently heavy and attaining a sufficient velocity submerge into the transfer component through the lower water surface, and the electric generator configured to interact with the power module to generate electric power when the power module falls by gravity between the launcher and the open access port; and
the open access port configured to close and the closed transfer port configured to open to establish a pathway for the power module from the transfer component to the return component when the power module is submerged in the transfer component, the power module including a buoyancy sufficient to enable the power module to ascend upwardly through the confined volume of water along the pathway from the transfer component to the return component and through the return component to the upper water surface.

22. The apparatus according to claim 21, further comprising:
the power module including a displacement volume; and
a displacement device configured to move into and out of a displaced position in the transfer component for alternately displacing a volume of the confined volume of water equal to the displacement volume.

23. The apparatus according to claim 21, the power module comprising:
an elongate body including a first end and a second end; and
the buoyancy configured to enable the elongate body to remain upright from the first end to the second end when the elongate body is submerged in the confined volume of water.

24. The apparatus according to claim 21, wherein the launcher comprises a platform mounted to displace into and out of the launching position.

25. Apparatus, comprising:
a bi-level tank comprising a transfer tank including an access port and a transfer port, a return tank extending upright from the transfer port to an outlet above the access port, a first valve configured to switch into and out of a closed position closing the access port, and a second valve configured to switch into and out of a closed position closing the transfer port, the bi-level tank filled with water to define a lower water surface under the access port and an upper water surface proximate to the outlet, and the second valve switched into its closed position isolating the water in the return tank from the water in the transfer tank;
an electric generator between the access port and a power module supported by a launcher proximate to the outlet, the launcher configured to move into and out of a launching position for releasing the power module from the launcher, the power module configured to fall by gravity from the launcher into the transfer tank through the access port when the first valve is switched out of its closed position opening the access port and by being sufficiently heavy and attaining a sufficient velocity submerge into the water through the lower water surface, and the electric generator configured to interact with the power module to generate electric power when the power module falls by gravity between the launcher and the access port; and
the first valve configured to switch into its closed position closing the access port and the second valve configured to switch out of its closed position to establish a pathway for the power module from the water in transfer tank to the water in the return tank when the power module is submerged in the water in the transfer tank, the power module including a buoyancy sufficient to enable the power module to ascend upwardly through the water along the pathway from the water in the transfer tank to the water in the return tank and through the water in return tank to the upper water surface proximate to the outlet.

26. The apparatus according to claim 25, further comprising:
the power module including a displacement volume; and
a displacement device configured to move into and out of a displaced position in the water in the transfer tank for alternately displacing a volume of the water equal to the displacement volume.

27. The apparatus according to claim 25, the power module comprising:
an elongate body including a first end and a second end; and
the buoyancy configured to enable the elongate body to remain upright from the first end to the second end when the elongate body is submerged in the water.

28. The apparatus according to claim 25, wherein the launcher comprises a platform mounted to displace into and out of the launching position.

29. A method, comprising:
providing a confined volume of water comprising a transfer component defining a lower water surface and a return component extending upright from the transfer component to an upper water surface above the lower water surface, an open access port over the lower water surface, a closed transfer port isolating the return component from the transfer component, and an electric generator between the upper water surface and the open access port;
releasing a power module from an elevated location over the open access port and proximate to the upper water surface, the power module falling by gravity into the transfer component through the open access port and by being sufficiently heavy and attaining a sufficient velocity submerging in the transfer component through the lower water surface, and the electric generator interacting with power module falling by gravity between the upper water surface and the open access port generating electric power; and
closing the open access port and opening the closed transfer port establishing a pathway for the power module from the transfer component to the return component upon the power module submerging in the transfer component, the power module including a buoyancy sufficient to enable the power module to ascend upwardly through the confined volume of water along the pathway from the transfer component to the return component and through the return component to the upper water surface.

30. The method according to claim 29, further comprising:
the power module including a displacement volume; and
displacing a volume of the confined volume of water of the transfer component equal to the displacement volume after the steps of opening the closed transfer port upon the power module submerging in the transfer component.

31. The method according to claim 30, further comprising reversing the step of displacing upon the power module ascending into the return component along the pathway from the transfer component.

32. The method according to claim 29, the power module comprising:
an elongate body including a first end and a second end; and
the buoyancy orienting the elongate body upright from the first end to the second end when the elongate body is submerged in the confined volume of water.

33. The method according to claim 29, wherein the step of releasing the power module comprises:
providing a launcher proximate to the upper water surface, the launcher movable between a supporting position and a launching position;
supporting the power module by the launcher in the supporting position; and
moving the launcher into the launching position from the supporting position.

34. A method, comprising:
providing a confined volume of water comprising a transfer component defining a lower water surface and a return component extending upright from the transfer component to an upper water surface above the lower water surface, an access port over the lower water surface, a transfer port between the return component and the transfer component, an electric generator between the upper water surface and the access port, a first valve configured to switch into and out of a closed position closing the access port, and a second valve configured to switch into and out of a closed position closing the transfer port isolating the return component from the transfer component, the first valve switched out of its closed position opening the access port and the second valve switched into its closed position closing the transfer port;
releasing a power module from an elevated location over the access port and proximate to the upper water surface, the power module falling by gravity into the transfer component through the access port and by being sufficiently heavy and attaining a sufficient velocity submerging in the transfer component through the lower water surface, and the electric generator interacting with power module falling by gravity between the upper water surface and the access port generating electric power; and
switching the first valve into its closed position closing the access port and switching the second valve out of its closed position opening the transfer port establishing a pathway for the power module from the transfer component to the return component upon the power module submerging in the transfer component, the power module including a buoyancy sufficient to enable the power module to ascend through the confined volume of water along the pathway from the transfer component to the return component and through the return component to the upper water surface.

35. The method according to claim 34, further comprising:
the power module including a displacement volume; and
displacing a volume of the confined volume of water equal to the displacement volume from the transfer component to the return component after the steps of switching the second valve out of its closed position upon the power module submerging in the transfer component.

36. The method according to claim 35, further comprising reversing the step of displacing upon the power module ascending into the return component along the pathway from the transfer component.

37. The method according to claim 34, the power module comprising:
an elongate body including a first end and a second end; and
the buoyancy orienting the elongate body upright from the first end to the second end when the elongate body is submerged in the confined volume of water.

38. The method according to claim 34, wherein the step of releasing the power module comprises:
providing a launcher proximate to the upper water surface, the launcher movable between a supporting position and a launching position;
supporting the power module by the launcher in the supporting position; and
moving the launcher into the launching position from the supporting position.
